(19) United States
(12) Patent Application Publication
(10) Pub. No.: US 2025/0174052 A1
(43) Pub. Date: May 29, 2025

(54) SELECTIVE DATA COLLECTION FROM REMOTE DEVICES

(71) Applicant: Ford Global Technologies, LLC, Dearborn, MI (US)

(72) Inventors: Omar Makke, Oakland, MI (US); Oleg Gusikhin, Commerce Township, MI (US); Vicky Svidenko, Newcastle, WA (US); Syam Chand Kamarajugadda, Machilipatnam (IN); Vamsee Krishna Batchu, Chennai (IN)

(73) Assignee: Ford Global Technologies, LLC, Dearborn, MI (US)

(21) Appl. No.: 18/522,379

(22) Filed: Nov. 29, 2023

(51) Int. Cl. G07C 5/00; G06F 18/241

(52) U.S. Cl. CPC G07C 5/008; G06F 18/241

(57) ABSTRACT

A computer is programmed to determine a relationship between a confidence level and a cost rating for collecting a set of data from a plurality of remote devices, then receive an input selecting a confidence value for the confidence level and cost value for the cost rating, select an actual sample of the remote devices according to the confidence value, and transmit a request for the set of the data to the remote devices in the actual sample. The confidence level indicates a statistical confidence in the set of data based on a candidate sample of the remote devices. The cost rating indicates a cost of collecting the set of data from the candidate sample of the remote devices. The confidence value and the cost value are consistent with the relationship between the confidence level and the cost rating.

### BACKGROUND

A distributed system is a computational system whose components are located on different networked computers. The networked computers communicate and coordinate their actions by passing messages to one another. The networked computers are independent of each other, and each networked computer has its own local memory.

### BRIEF DESCRIPTION OF THE DRAWINGS

FIG. 1 is a block diagram of an example communication system between a computer and remote devices.

FIG. 2 is a diagram of a mapping between features of the remote devices and classification names for data transmissions related to the features.

FIG. 3 is a diagram of an example sampling of the remote devices.

FIG. 4 is a flowchart of an example process for collecting data from the remote devices.

### DETAILED DESCRIPTION

The system described herein provides a resource-efficient way to capture data from remote devices, such as vehicles, that are part of a distributed system with a central computer. Distributed systems can face challenges in efficiently transferring relevant data. Vehicles, as well as some other types of remote devices, can generate large quantities of data, and collecting, including communicating and storing, all of that data may be impractical and/or technically infeasible because of, e.g., limitations in available memory and/or computer network bandwidth. For example, different remote devices may have different per-device bandwidth limits. In the system described herein, a computer is programmed to determine a relationship between a confidence level and a cost rating for collecting a set of data from a plurality of remote devices, then receive an input selecting a confidence value for the confidence level and cost value for the cost rating, select an actual sample of the remote devices according to the confidence value, and transmit a request for the set of the data to the remote devices in the actual sample. The confidence level indicates a statistical confidence in the set of data based on a candidate sample of the remote devices. The cost rating indicates a cost of collecting the set of data from the candidate sample of the remote devices, i.e., the technical effort in terms of processor cycles, bandwidth usage, etc. The confidence value and the cost value are consistent with the relationship between the confidence level and the cost rating. For example, the input may include a number for the confidence value, from which the cost value is determined according to the relationship, or the input may include a number for the cost value, from which the confidence value is determined according to the relationship. The system thereby conserves resources such as available memory and network bandwidth while still capturing the data that is most interesting to the user.

A computer includes a processor and a memory, and the memory stores instructions executable by the processor to determine a relationship between a confidence level and a cost rating for collecting a set of data from a plurality of remote devices, then receive an input selecting a confidence value for the confidence level and cost value for the cost rating, select an actual sample of the remote devices according to the confidence value, and transmit a request for the set of the data to the remote devices in the actual sample. The confidence level indicates a statistical confidence in the set of data based on a candidate sample of the remote devices. The cost rating indicates a cost of collecting the set of data from the candidate sample of the remote devices. The confidence value and the cost value are consistent with the relationship between the confidence level and the cost rating.

In an example, the remote devices may be vehicles.

In an example, the set of data may be defined by a set of characteristics of the data. In a further example, the characteristics may include a model of the remote device.

In another further example, the characteristics may include a geographic area containing the remote device.

In another further example, the characteristics may include use of a feature of the remote device. In a yet further example, the instructions may further include instructions to select a plurality of classifications of data transmitted within the remote device for inclusion in the set of data according to a mapping that associates the classifications with the feature. In a still yet further example, the instructions may further include instructions to determine a classification name for at least one of the classifications, the classification name specific to a model of the remote devices; and include the classification name in the request to the remote devices.

In another still yet further example, the feature may be a first feature; the classifications may be first classifications; the mapping may associate second classifications with a second feature; and the instructions may further include instructions to output a prompt to a user suggesting that the user add the second feature to the set of characteristics in response to an overlap between the first classifications and the second classifications.

In another yet further example, the feature may be a first feature, and the instructions may further include instructions to output a prompt to a user suggesting that the user add a second feature to the set of characteristics in response to a correlation between requests for the first feature and requests the second feature.

In another further example, the characteristics may include an event affecting the remote device.

In another further example, the input may be a second input, and the instructions may further include instructions to receive a first input specifying the characteristics.

In another further example, the instructions may further include instructions to determine a population of the remote devices based on the characteristics and randomly select the actual sample from the population. In a yet further example, the characteristics may be first characteristics; the actual sample may be a first actual sample; and the instructions may further include instructions to select a second actual sample of the remote devices based on second characteristics that are correlated with the first characteristics.

In an example, the instructions may further include instructions to receive an input specifying a maximum value for the cost rating and determine a candidate confidence value according to the relationship between the confidence level and the cost rating.

In an example, the instructions may further include instructions to receive an input specifying a minimum value for the confidence level and determine a candidate cost value according to the relationship between the confidence level and the cost rating.

In an example, the instructions may further include instructions to select the actual sample of the remote devices based on bandwidth limits of the respective remote devices in the actual sample.

In an example, the cost rating may be a function of a number of the remote devices in the actual sample.

In an example, the confidence level may be a function of a number of the remote devices in the actual sample.

A method includes determining a relationship between a confidence level and a cost rating for collecting a set of data from a plurality of remote devices, then receiving an input selecting a confidence value for the confidence level and cost value for the cost rating, selecting an actual sample of the remote devices according to the confidence value, and transmitting a request for the set of the data to the remote devices in the actual sample. The confidence level indicates a statistical confidence in the set of data based on a candidate sample of the remote devices. The cost rating indicates a cost of collecting the set of data from the candidate sample of the remote devices. The confidence value and the cost value are consistent with the relationship between the confidence level and the cost rating.

With reference to the Figures, wherein like numerals indicate like parts throughout the several views, a computer 100 includes a processor and a memory, and the memory stores instructions executable by the processor to determine a relationship between a confidence level and a cost rating for collecting a set of data from a plurality of remote devices 105, then receive an input selecting a confidence value for the confidence level and cost value for the cost rating, select an actual sample 305, 310 of the remote devices 105 according to the confidence value, and transmit a request for the set of the data to the remote devices 105 in the actual sample 305, 310. The confidence level indicates a statistical confidence in the set of data based on a candidate sample of the remote devices 105. The cost rating indicates a cost of collecting the set of data from the candidate sample of the remote devices 105. The confidence value and the cost value are consistent with the relationship between the confidence level and the cost rating.

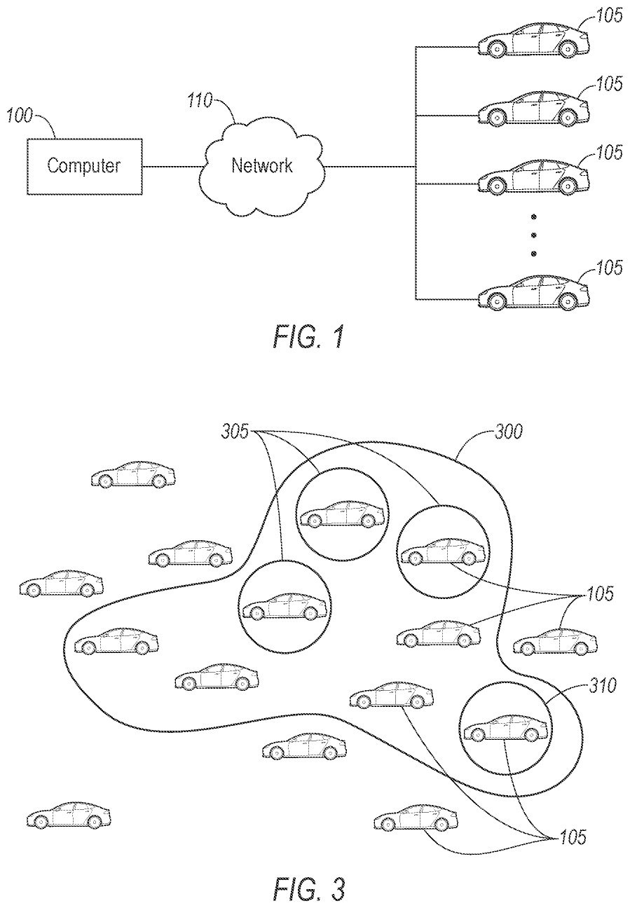

With reference to FIG. 1, the computer 100 is a microprocessor-based computing device, e.g., a generic computing device including a processor and a memory. The memory of the computer 100 can include media for storing instructions executable by the processor as well as for electronically storing data and/or databases, and/or the computer 100 can include structures such as the foregoing by which programming is provided. The computer 100 can be multiple computers coupled together.

The computer 100 may communicate with the remote devices 105 over a network 110. The network 110 represents one or more mechanisms by which the computer 100 may communicate. Accordingly, the network 110 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The remote devices 105 are or include computing devices. The remote devices 105 may be mobile, i.e., capable of physically moving around or being moved around while in operation. For example, the remote devices 105 may be vehicles, as depicted in FIG. 1. The vehicles may be any passenger or commercial automobile such as a car, a truck, a sport utility vehicle, a crossover, a van, a minivan, a taxi, a bus, etc. For another example, the remote devices 105 may be portable computing devices such as cellular phones, tablets, wearable computing devices such as smartwatches, etc. The techniques described herein are especially useful for gathering data from mobile remote devices 105 with potentially limited bandwidth such as vehicles.

The remote devices 105 may have bandwidth limits. The bandwidth limits are caps on a quantity or rate of data transmitted by the remote devices 105 to the network 110. The bandwidth limits may be specific to the remote devices 105; i.e., different remote devices 105 may have different bandwidth limits. The bandwidth limits may be specified by the model of the remote device 105; e.g., certain models of the remote devices 105 may have a bandwidth limit of 12 MB per month, and other models may have a bandwidth limit of 30 MB per month.

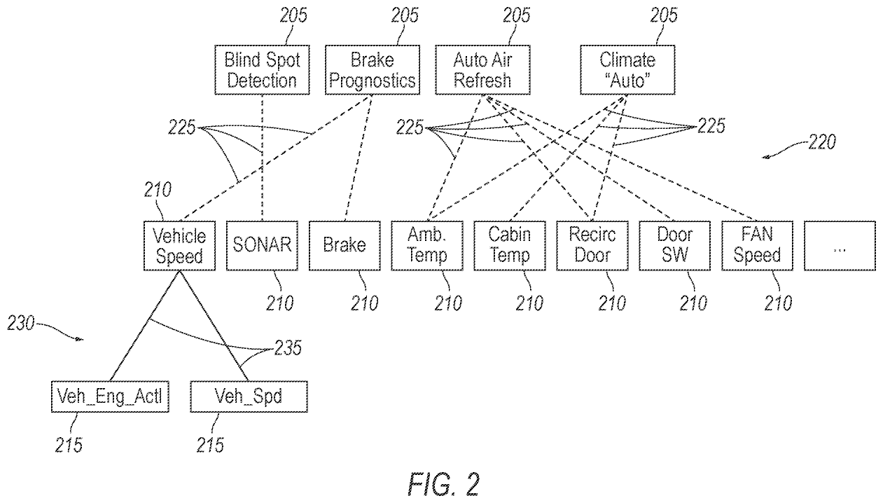

With reference to FIG. 2, the remote device 105 may generate data as a result of normal operation, i.e., not in response to requests from the computer 100. The data includes data transmitted within the remote device 105, e.g., sent over a communications network or bus of the remote device 105. The data can include structured data and unstructured data. Structured data is data that is organized in a standardized format. For example, data that is sent through a controller area network (CAN) bus of a vehicle is typically in the Database Container (.dbc) file format, which is a type of structured data. Some sensors, such as cameras, can produce unstructured data. The data may be time-series data. As will be generally understood, and for purposes of this disclosure, time-series data are values of one or more variables at discrete successive points of time.

As described below, the computer 100 determines a set of data to collect from the remote devices 105, and the set of data is a subset of all the data generated on the remote devices 105. The set of data is defined by a set of characteristics of the data. For the purposes of this disclosure, a “characteristic” of the data is a fact that is true of some of the data generated by the remote devices 105. Each characteristic thereby defines a subset of the data generated by the remote devices 105, i.e., the subset for which the characteristic holds or is true. For example, characteristics may include features 205 of the remote devices 105, classifications 210 of the data, classification names 215 of the data, models of the remote devices 105, geographic areas that may contain the remote devices 105, environmental conditions around the remote devices 105 when the data is generated, time and/or date when the data is generated, and/or events affecting the remote devices 105 when the data is generated, each of which will be described in turn below. The characteristics may also include other types of facts, e.g., demographic data about owners or operators of the remote devices 105 such as ages, data describing the quality of the remote devices 105, etc.

The characteristics may include use of a feature 205 of the remote devices 105. A feature 205 is some capability of the remote device 105. As an example for vehicles, the features 205 may include advanced driver assistance systems (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. For another example, the features 205 may include basic operation of the vehicle, e.g., braking, accelerating, steering, etc. For another example, the features 205 may include vehicle monitoring such as brake prognostics (e.g., life cycle estimation for the brakes), diagnostic trouble codes (DTCs), etc. Other examples of features 205 include climate control for a passenger compartment of the vehicle, infotainment options, status and operation of vehicle components such as lights, door latches and locks, sensors, etc.

The characteristics may include the classifications 210 of the data. A classification 210 is a type of data, e.g., a type of data transmitted within the remote device 105, e.g., a type of payload in a message sent over the communications network or bus of the vehicle. For example, the classifications 210 may include types of sensor data such as vehicle speed, sonar, ambient temperature, temperature of the passenger compartment, etc. The classifications 210 may also include commands to components, e.g., braking force, fan speed, etc.

The computer 100 may store a first mapping 220 that associates the classifications 210 with the features 205. The first mapping 220 includes a plurality of first associations 225 between the features 205 and the classifications 210. Each first association 225 between a feature 205 and a classification 210 indicates that the feature 205 uses the classification 210, i.e., that the execution or operation of the feature 205 is based on the classification 210. For example, brake prognostics (a feature 205) determines an estimation of life cycle for the brakes based on data including vehicle speed and braking force (classifications 210) over time. The computer 100 may be programmed to determine the classifications 210 for a given feature 205 according to the first mapping 220, i.e., by consulting the first mapping 220. The computer 100 may be programmed to select a plurality of classifications 210 of data transmitted within the remote device 105 for inclusion in the set of data according to the first mapping 220, e.g., by selecting the classifications 210 determined to be associated with a feature 205 of interest, e.g., a feature 205 identified by an input from a user. The first mapping 220 may be stored in the memory of the computer 100, e.g., as a set of feature-classification pairs (e.g., {(Feature A, Classification A), (Feature A, Classification B), . . . }) or as a matrix with a column for each feature 205 and a row for each classification 210 (or vice versa) with a binary variable in each entry indicating whether the feature 205 for that column and the classification 210 for that row are or are not associated.

The classifications 210 have classification names 215. The classification names 215 are identifiers used within the remote devices 105 to refer to the classifications 210. The classification names 215 may be specific to one or more models of the remote devices 105. In other words, the classification name 215 for a specific classification 210 may be different on different models of remote devices 105. For example, vehicle speed (a classification 210), i.e., how fast the vehicle is traveling, may be identified as “Veh_Eng_Actl” (a classification name 215) on some models of vehicles and as “Veh_Spd” (a classification name 215) on other models of vehicles.

The computer 100 may store a second mapping 230 that associates the classification names 215 with the classifications 210. The second mapping 230 includes a plurality of second associations 235 between the classifications 210 and the classification names 215. Each second association 235 between a classification 210 and a classification name 215 indicates that the classification name 215 refers to the classification 210 on some model of remote device 105. The computer 100 may be programmed to determine the classification name 215 for a given classification 210 and model of remote device 105 according to the second mapping 230, i.e., by consulting the second mapping 230. The second mapping 230 may be stored in the memory of the computer 100, e.g., as a matrix with a column for each classification 210 and a row for each model of remote device 105 (or vice versa) with each entry including the classification name 215 for the classification 210 of that column that is used in the model of remote device 105 for that row.

The characteristics may include the model of the remote device 105. The model of a remote device 105 is the specific product design or version that the remote device 105 embodies in the context of the manufacturer's range or series of products.

The characteristics may include a geographic area containing the remote device 105, e.g., when the remote device 105 generates the data of interest. As an example for vehicles, the geographic area may be specified by a type of road on which the vehicle is traveling, e.g., limited-access highway, standard highway, city street, residential street, gravel road, parking lot, etc., or by an identity of the road on which the vehicle is traveling, e.g., Route 66. For another example, the geographic area may be specified by municipal or jurisdictional boundaries; by population density, e.g., urban, suburban, rural; by state or country; by some combination of the foregoing; etc.

The characteristics may include one or more environmental conditions experienced by the remote device 105 while the remote device 105 generates the data of interest. Environmental conditions may include traffic density, type of road surface (e.g., paved or gravel), weather, etc. Weather may include precipitation (e.g., rain, snow, no precipitation, etc.), cloud cover (e.g., sunny, partly cloudy, cloudy, etc.), visibility (e.g., foggy, hazy, clear, etc.), ambient temperature, and so on. The remote device 105 may determine the environmental conditions using built-in sensors such as shock sensors for type of road surface, rain sensors, temperature sensors, light sensors, etc. Alternatively or additionally, the remote device 105 may receive external data from the network 110 indicating environmental conditions such as traffic density and weather.

The characteristics may include the time at which the remote device 105 generates the data of interest. The time of interest may be specified using ranges for time of day, day of the week, and/or date. For example, the data of interest may be data generated during rush hour, specified as particular hours during weekdays.

The characteristics may include an event affecting the remote device 105 when the data is generated. For example, the event may be defined as when some quantity is above or below a threshold or inside or outside of a range. For example, an event may occur when braking force or deceleration is above a threshold.

With reference to FIG. 3, the computer 100 may be programmed to determine a population 300 of the remote devices 105 based on a set of the characteristics. The population 300 is a collection of the remote devices 105 that have the set of the characteristics. For example, if the characteristics are that the model is Model A and that the feature 205 is Auto Air Refresh, then the population 300 includes all the remote devices 105 that are Model A and that are equipped with Auto Air Refresh, and the population 300 excludes the other remote devices 105, e.g., remote devices 105 that are Model B, or remote devices 105 that are Model A but lack Auto Air Refresh. The computer 100 may receive the set of the characteristics as an input. The computer 100 may consult some listing of the characteristics of specific remote devices 105, e.g., a database of the remote devices 105 associated with their respective characteristics. The remote devices 105 may be identified in the database or the like by unique identifiers, e.g., vehicle identification numbers (VINs). The database may specify the characteristics that represent or indicate static properties of the remote devices 105, e.g., model, feature 205, classification 210, and not the characteristics that represent or indicate transient properties, e.g., geographic area, environmental conditions, time, event.

The computer 100 may be programmed to randomly select an actual sample 305, 310 from the population 300 based on inputs from a user. The actual sample 305, 310 is the set of the remote devices 105 from which the data will be collected. As a general overview, the computer 100 may determine the population 300 from the characteristics inputted by the user, as described above. The computer 100 determines a relationship between a confidence level and a cost rating for collecting the set of data from the remote devices 105. The set of data may be specified by an input from a user, e.g., the input listing the characteristics. The relationship describes a tradeoff between the confidence level and the cost rating, i.e., a higher confidence value generally requires a higher cost value. The computer 100 may select a point on the relationship between the confidence level and the cost rating based on an input from the user, the point represented by a confidence value and a cost value. The input may include either the confidence value or the cost value, and the computer 100 may determine the other of the confidence value and the cost value according to the relationship. The computer 100 may then randomly select the actual sample 305, 310 from the population 300 of the remote devices 105 to achieve the selected confidence level and transmit a request for the set of the data to the remote devices 105 in the actual sample 305, 310.

The cost rating indicates a cost of collecting the set of data from a candidate sample of the remote devices 105. The cost represents the technical effort in obtaining the set of data from the remote devices 105, e.g., processor cycles, bandwidth usage, etc. Different types of cost may be converted to common units to make different types of technical effort commensurable. The cost rating may be a function of a quantity of the set of the data to be collected, e.g., C=f(X), in which C is cost rating and X is the quantity of data to be collected. The function may define a positive relationship between data quantity and cost rating, i.e., increasing the data quantity causes an increase in the cost rating. For example, the function may be a linear relationship between cost rating and quantity of data to be collected, i.e., C=mX, in which m is a cost per unit data. For another example, the function may be a combination of different linear relationships for subpopulations of the population 300, e.g., as in the following formula for the case of two subpopulations:

$$C = ( {m}_{1} k + {m}_{2} ( 1 - k ) ) X$$

in which m₁ and m₂ are respective costs per unit data for first and second subpopulations, and k is the proportion of the population 300 in the first subpopulation. The cost rating may be a function of a number of the remote devices 105 in the sample, e.g., by virtue of the quantity of the set of data to be collected and quantity of data to be collected from each remote device 105, e.g., X=Nx, in which N is the number of remote devices 105 in the sample and x is the data collected per remote device 105. The data per remote device 105 x may be capped at the bandwidth limit.

The confidence level indicates a statistical confidence in the set of data based on a candidate sample of the remote devices 105. The confidence level may be a function of the quantity of the set of the data to be collected, e.g., according to Cochran's formula, as is known in statistics. Cochran's formula is given by the following expression:

$$X = \frac{{Z}^{2} p ( 1 - p )}{{e}^{2}}$$

in which Z is a z-value indicating the confidence level, p is an estimated proportion of the data available to be collected that exhibits a property of interest, and e is the desired margin of error. The confidence level may be a function of a number of the remote devices 105 in the sample, e.g., by virtue of the quantity of the set of data to be collected and quantity of data to be collected from each remote device 105, as described above for the cost rating.

The computer 100 is programmed to determine the relationship between the confidence level and the cost rating for collecting the set of data from the population 300 of the remote devices 105. For example, the computer 100 may define the relationship parametrically in terms of the quantity of data to be collected by using formulas as described above for cost rating as a function of quantity of data to be collected and for confidence level as a function of data to be collected. For another example, the computer 100 may determine an expression directly relating the cost rating and the confidence level by solving a system of equations with the formulas described above. The relationship represents a tradeoff between cost and confidence, with greater confidence generally requiring higher cost.

The computer 100 may be programmed to determine a candidate cost value and a candidate confidence value from an input by a user based on the relationship between the confidence level and the cost rating. The input from the user may effectively select a point on the relationship, e.g., by specifying either a minimum value for the confidence level or a maximum value for the cost rating, with the other quantity being determined consistent with the relationship, e.g., by solving the formulas described above. For example, the computer 100 may receive an input specifying a minimum value for the confidence level, which is used as the candidate confidence value, and the computer 100 may then determine a candidate cost value based on the candidate confidence value consistent with the relationship. The candidate cost value may be the smallest cost value that provides at least the inputted minimum value for the confidence level. For another example, or during a different execution or iteration, the computer 100 may receive an input specifying a maximum value for the cost rating, which is used as the candidate cost value, and the computer 100 may then determine a candidate confidence value based on the candidate cost value consistent with the relationship. The candidate confidence value may be the greatest confidence value achievable within the inputted maximum value for the cost rating.

The computer 100 may be programmed to provide an option to the user to iterate the steps above with different inputs. The computer 100 may output the candidate cost value and candidate confidence value, and the user may then input a command for the computer 100 to permit new inputs. The user may provide a different set of characteristics, a different minimum value for the confidence level, and/or a different maximum value for the cost rating, and the computer 100 may thereby arrive at a different candidate cost value and/or candidate confidence value. Once the user is done iterating, the values of the final candidate cost value and final candidate confidence value are used as the cost value and confidence value, respectively.

The computer 100 may be programmed to output a prompt to a user suggesting that the user add a feature 205 to the set of characteristics. The user may then include the suggested feature 205 in the next iteration. For example, the computer 100 may output the prompt in response to an overlap between the classifications 210 associated with the suggested feature 205 and the classifications 210 associated with one of the features 205 already in the set of characteristics. The computer 100 may determine that an overlap is present between two features 205 in response to a number or proportion of the classifications 210 associated with both of the features 205 exceeding a threshold. For another example, the computer 100 may output the prompt in response to a correlation between requests for the suggested feature 205 and requests for one of the features 205 already in the set of characteristics. The correlation is a statistical relationship between the two features 205, e.g., a likelihood of the two features 205 being selected together by past users. The computer 100 may output the prompt in response to the correlation exceeding a threshold. For another example, the computer 100 may output the prompt based on an output of a recommender system being executed by the computer 100. The recommender system may be any suitable algorithm for recommending a choice to a user based on choices made by past users, e.g., collaborative filtering, content-based filtering, hybrid filtering, etc.

The computer 100 is programmed to select a first actual sample 305 of the remote devices 105 according to the confidence value. For example, the computer 100 may select a number of the remote devices 105 from the population 300 to provide a quantity of data sufficient to satisfy Cochran's formula with the confidence value inputted. Selecting the first actual sample 305 may be based on the bandwidth limits of the remote devices 105 in the first actual sample 305; e.g., lower bandwidth limits requires selecting a larger number of remote devices 105 to produce the same quantity of data. The computer 100 may select the first actual sample 305 by randomly sampling the unique identifiers for the remote devices 105 in the population 300. Alternatively or additionally, the computer 100 may divide the population 300 into clusters according to the characteristics and randomly sample from each cluster, to ensure that all of the characteristics are well represented in the first actual sample 305.

The computer 100 may be programmed to select a second actual sample 305 of the remote devices 105 based on characteristics that are not included in the characteristics used to select the first actual sample 305. The additional characteristics may be correlated with the already-included characteristics, e.g., a higher likelihood of the characteristics appearing together in the same remote devices 105. The second actual sample 305 may thus collect data on characteristics that are especially cost-effective. The computer 100 may select the second actual sample 305 from a population 300 in the same manner as the first actual sample 305.

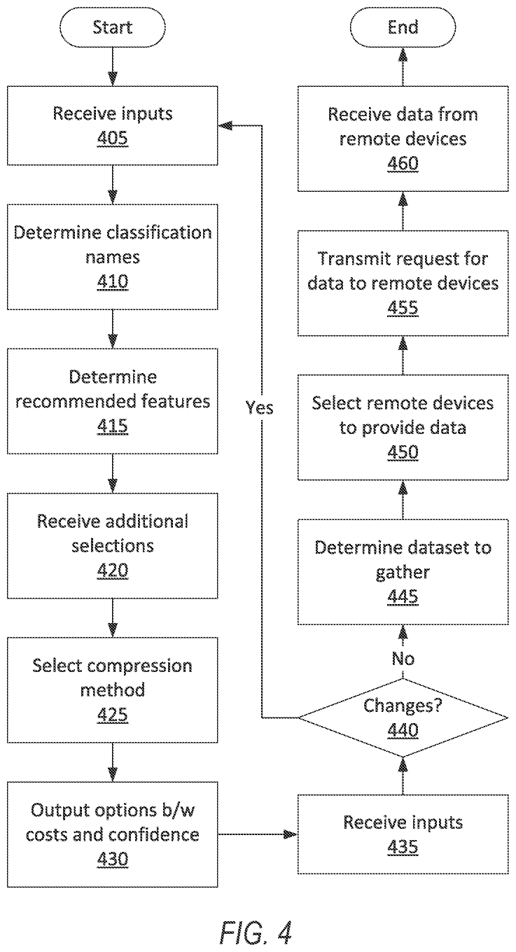

FIG. 4 is a flowchart illustrating an example process 400 for collecting the data from the remote devices 105. The memory of the computer 100 stores executable instructions for performing the steps of the process 400 and/or programming can be implemented in structures such as mentioned above. As a general overview of the process 400, the computer 100 receives inputs, determines classification names 215, determines recommended features 205, receives additional selections of features 205, selects a compression method, outputs the relationship between the cost rating and the confidence level, and receives an input selecting the cost value and confidence value. The computer 100 iterates the foregoing steps for as long as the user would like to change the inputs. Next, the computer 100 determines the definition of the set of data to include in the request, selects the actual sample 305, 310 of the remote devices 105, transmits the request to the remote devices 105, and receives the requested data from the remote devices 105.

The process 400 begins in a block 405, in which the computer 100 receives an input specifying the characteristics and an input specifying either a maximum value for the cost rating or a minimum value for the confidence level.

Next, in a block 410, the computer 100 determines the classification names 215 covered by the characteristics received in the block 405. The computer 100 determines the classifications 210 according to the first mapping 220 for the features 205 included in the characteristics, and the computer 100 determines the classification names 215 for those classifications 210 (and for any other classifications 210 included in the inputted characteristics) according to the second mapping 230, as described above.

Next, in a block 415, the computer 100 outputs a prompt to the user suggesting that the user add recommended features 205, as described above.

Next, in a block 420, the computer 100 receives an input specifying which, if any, of the recommended features 205 to add to the characteristics.

Next, in a block 425, the computer 100 selects a compression method for the remote devices 105 to use when transmitting the requested data to the computer 100. The compression method may be chosen from a set of possible compression methods suitable for data from the remote devices 105, e.g., no compression, compressive sensing, wavelets, principal component analysis (PCA), autoencoders, etc. For example, the user may provide an input selecting the compression method. For another example, the computer 100 may determine the compression method based on the characteristics received in the block 405, e.g., based on the classifications 210. The computer 100 may consult a lookup table pairing classifications 210 with compression methods. The pairings may be chosen based on how data-intensive the classification 210 is and based on empirical testing of the compression methods on different classifications 210. As one example, numerical time-series data may be uncompressed, image data may be compressed with PCA, etc.

Next, in a block 430, the computer 100 determines the relationship between the confidence level and the cost rating, as described above. The cost rating may depend on the compression method selected in the block 425. For example, the cost rating may be reduced by the percentage compression of the selected compression method, e.g., C=(1−k)C_{unc}, in which k is the percentage reduction from compressing the data according to the compression method and C_{unc} is the cost rating of the uncompressed data. The cost rating of the uncompressed data C_{unc} may be determined as described above for the cost rating.

Next, in a block 435, the computer 100 receives an input selecting a confidence value for the confidence level and cost value for the cost rating. For example, the input may specify the minimum value for the confidence level, from which the computer 100 determines the cost value, or the input may specify the maximum value for the cost rating, from which the computer 100 determines the confidence value. In either case, the determination ensures that the confidence value and the cost value are consistent with the relationship between the confidence level and the cost rating.

Next, in a decision block 440, the computer 100 determines whether the user would like to iterate the determination of the confidence value and cost value. For example, the computer 100 may determine whether the computer 100 has received an input providing new characteristics or values or requesting to provide new characteristics or values. In response to a request to iterate, the process 400 returns to the block 405 to receive new inputs. In response to the user being finished, the process 400 proceeds to a block 445.

In the block 445, the computer 100 determines the definition of the data to request from the remote devices 105. The data may be defined according to the classification names 215 for the classifications 210 selected from the final iteration, along with any classifications 210 recommended for the second actual sample 305, as described above.

Next, in a block 450, the computer 100 determines the population 300 based on the characteristics, and the computer 100 selects the first actual sample 305 and second actual sample 305 of the remote devices 105 from the population 300 according to the confidence value by random sampling, as described above.

Next, in a block 455, the computer 100 transmits requests for the set of the data defined in the block 445 to the remote devices 105 in the first and second actual samples 305, 310 from the block 450, via the network 110. The computer 100 includes the classification names 215 in the requests to the remote devices 105 according to the second mapping 230, as described above, so that the requests can be properly interpreted by all the remote devices 105.

Next, in a block 460, the computer 100 receives the requested data from the remote devices 105 via the network 110. After the block 460, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
determine a relationship between a confidence level and a cost rating for collecting a set of data from a plurality of remote devices, the confidence level indicating a statistical confidence in the set of data based on a candidate sample of the remote devices, the cost rating indicating a cost of collecting the set of data from the candidate sample of the remote devices;
then receive an input selecting a confidence value for the confidence level and cost value for the cost rating, the confidence value and the cost value being consistent with the relationship between the confidence level and the cost rating;
select an actual sample of the remote devices according to the confidence value; and
transmit a request for the set of the data to the remote devices in the actual sample.

2. The computer of claim 1, wherein the remote devices are vehicles.

3. The computer of claim 1, wherein the set of data is defined by a set of characteristics of the data.

4. The computer of claim 3, wherein the characteristics include a model of the remote device.

5. The computer of claim 3, wherein the characteristics include a geographic area containing the remote device.

6. The computer of claim 3, wherein the characteristics include use of a feature of the remote device.

7. The computer of claim 6, wherein the instructions further include instructions to select a plurality of classifications of data transmitted within the remote device for inclusion in the set of data according to a mapping that associates the classifications with the feature.

8. The computer of claim 7, wherein the instructions further include instructions to:
determine a classification name for at least one of the classifications, the classification name specific to a model of the remote devices; and
include the classification name in the request to the remote devices.

9. The computer of claim 7, wherein
the feature is a first feature;
the classifications are first classifications;
the mapping associates second classifications with a second feature; and
the instructions further include instructions to output a prompt to a user suggesting that the user add the second feature to the set of characteristics in response to an overlap between the first classifications and the second classifications.

10. The computer of claim 6, wherein
the feature is a first feature; and
the instructions further include instructions to output a prompt to a user suggesting that the user add a second feature to the set of characteristics in response to a correlation between requests for the first feature and requests the second feature.

11. The computer of claim 3, wherein the characteristics include an event affecting the remote device.

12. The computer of claim 3, wherein
the input is a second input; and
the instructions further include instructions to receive a first input specifying the characteristics.

13. The computer of claim 3, wherein the instructions further include instructions to:
determine a population of the remote devices based on the characteristics; and
randomly select the actual sample from the population.

14. The computer of claim 13, wherein
the characteristics are first characteristics;
the actual sample is a first actual sample; and
the instructions further include instructions to select a second actual sample of the remote devices based on second characteristics that are correlated with the first characteristics.

15. The computer of claim 1, wherein the instructions further include instructions to:
receive an input specifying a maximum value for the cost rating; and
determine a candidate confidence value according to the relationship between the confidence level and the cost rating.

16. The computer of claim 1, wherein the instructions further include instructions to:
receive an input specifying a minimum value for the confidence level; and
determine a candidate cost value according to the relationship between the confidence level and the cost rating.

17. The computer of claim 1, wherein the instructions further include instructions to select the actual sample of the remote devices based on bandwidth limits of the respective remote devices in the actual sample.

18. The computer of claim 1, wherein the cost rating is a function of a number of the remote devices in the actual sample.

19. The computer of claim 1, wherein the confidence level is a function of a number of the remote devices in the actual sample.

20. A method comprising:
determining a relationship between a confidence level and a cost rating for collecting a set of data from a plurality of remote devices, the confidence level indicating a statistical confidence in the set of data based on a candidate sample of the remote devices, the cost rating indicating a cost of collecting the set of data from the candidate sample of the remote devices;
then receiving an input selecting a confidence value for the confidence level and cost value for the cost rating, the confidence value and the cost value being consistent with the relationship between the confidence level and the cost rating;
selecting an actual sample of the remote devices according to the confidence value; and
transmitting a request for the set of the data to the remote devices in the actual sample.
